(19) United States
(12) Patent Application Publication
(10) Pub. No.: US 2024/0311704 A1
(43) Pub. Date: Sep. 19, 2024

(54) COMPUTER-IMPLEMENTED METHOD, COMPUTER PROGRAM, AND DEVICE FOR GENERATING A DATA-BASED MODEL COPY IN A SENSOR

(71) Applicant: Robert Bosch GmbH, Stuttgart (DE)

(72) Inventors: Armin Runge, Pittsburgh, PA (US); Christian Weiss, Leonberg (DE); Gor Hakobyan, Schoenaich (DE); Stefan Leidich, Rutesheim (DE)

(21) Appl. No.: 18/576,077

(22) PCT Filed: Jun. 14, 2022
(86) PCT No.: PCT/EP2022/066158

§ 371 Date: Jan. 2, 2024

(30) Foreign Application Priority Data
Jul. 6, 2021 (DE) 10 2021 207 094.9

(51) Int. Cl. G06N 20/20

(52) U.S. Cl. CPC G06N 20/20

(57) ABSTRACT

A device, a computer program, a computer-implemented method for generating a data-based model copy and a first sensor. The method includes: transforming specified raw data from a first sensor into data representing raw data of a second sensor; determining a first result with the specified raw data and with a first model designed to predict results based on raw data from the first sensor; determining a second result with the data representing the raw data of the second sensor and with a specified second model designed to predict results based on raw data from the second sensor; determining whether or not the first and second results differ. The method includes the following steps when the first result differs from the second result: determining a training data point including the specified raw data and the second result; training the first model with training data including the training data point.

### FIELD

The present invention relates to a computer-implemented method, a computer program, and a device for generating a data-based model copy in a sensor.

### BACKGROUND INFORMATION

Models are used in sensors, in particular for processing sensor data. Training data-based models is very complex and requires a large amount of training data and training iterations. Models trained once for a particular sensor cannot necessarily be used in a different sensor.

### SUMMARY

Automated generation of a data-based model copy of a model from one sensor for use in a different sensor for which a trained model already exists is therefore desirable.

The computer-implemented method, the computer program and the device according to features of the present invention make this possible.

According to an example embodiment of the present invention, the computer-implemented method for generating the data-based model copy comprises the following steps: transforming specified raw data from a first sensor into data representing raw data of a second sensor, determining a first result with the specified raw data and with a first model designed to predict results based on raw data from the first sensor, determining a second result with the data representing the raw data of the second sensor and with a specified second model designed to predict results based on raw data from the second sensor, determining whether or not the first result differs from the second result, wherein the method comprises the following steps if the first result differs from the second result: determining a training data point comprising the specified raw data and the second result, training the first model with training data comprising the training data point. On the basis of a discrepancy of the results between the first, new model and the old, second model, it is possible in the method to detect relevant data in the operation itself and to use them in the data-based model copy.

The raw data preferably represent at least one time domain signal, at least one spectrum, in particular of a radar, LiDAR, ultrasonic, infrared, or acoustic sensor, or at least one position, or filtered data or transformations thereof.

The first result and/or the second result preferably characterizes an object type or an estimate for a dimension of an object, or indicates whether or not a blind sensor, clustering, or an object has been detected.

According to an example embodiment of the present invention, it may be provided that the training of the first model takes place in a plurality of iterations, wherein values of parameters defining the first model are initialized with random values prior to a first one of the iterations. A starting point for the training is thereby provided with low resource costs.

According to an example embodiment of the present invention, it may be provided that the training takes place in a plurality of iterations, wherein, prior to a first one of the iterations, values of parameters defining the first model are determined or have been determined by training with raw data measured by means of the first sensor. This provides a pre-trained first model that is further refined by the training.

It may be provided that the training provides that a multitude of training data points is determined in a number of iterations, without performing a training step, wherein, subsequently, in particular in the first sensor or in a computing device outside the first sensor, a training step is performed, in which parameters defining the first model are determined with a portion of the training data points from the multitude of training data points or with the training data points from the multitude of training data points. For example, the training data points are collected in a memory. As a result, the training scales particularly well with regard to the available memory.

According to an example embodiment of the present invention, for initialization, the method may comprise determining a structure of the first model depending on a specified structure of the second model.

It may be provided that determining the structure of the first model comprises an architecture search with a machine learning system, in which architecture search the structure of the first model is determined depending on a specified structure of the second model. This makes it possible to adapt the first model automatically to a respective first sensor and/or second sensor.

It may be provided that determining the structure of the first model comprises copying at least a portion of a specified structure of the second model into the structure of the first model and/or copying values of at least a portion of specified parameters of the second model to values for parameters of the first model. As a result, the first model for the first sensor is particularly well adapted to the second model for the second sensor if these sensors have only slight differences.

Preferably, after at least one training step in which parameters defining the first model are determined, the first model is transmitted to a computing unit of the first sensor, which computing unit is designed to predict results with the first model for raw data measured by means of the first sensor. As a result, the first model is provided in the first sensor after the training.

According to an example embodiment of the present invention, the method may provide that the first model is transmitted from the computing unit to a computing device outside the first sensor, in particular at a specifiable or specified time, preferably at regular time intervals, that a third model is determined depending on the first model and at least one different model, and that the first model in the first sensor is replaced by the third model. For example, the local, first model of the first sensor is fused with the local models of various sensors at a global level and distributed. The advantage of this approach is the significantly reduced communication requirement since the respective local model is significantly smaller than the sum of the training data.

According to an example embodiment of the present invention, it may be provided that the method comprises the following steps if the first result differs from the second result: transmitting the training data point to a computing device outside the first sensor, determining a third result for the training data point, in particular with a different model designed to predict the third result for the training data point, determining a changed training data point by replacing the second result in the training data point with the third result, transmitting the changed training data point to the first sensor, training the first model with the changed training data point. As a result, the first model is additionally trained with a changed training data point determined outside the first sensor.

According to an example embodiment of the present invention, the method may provide that it is checked whether the second result for the training data point is correct or incorrect, wherein the changed training data point is determined and is used for the training of the first model if the second result is incorrect, and wherein the changed training data point is otherwise not determined and/or not used for the training of the first model. This detects and corrects a miscalculation of the second model. The training of the first model accordingly takes place not with the result of the miscalculation but with the correct result.

Further advantageous embodiments arise from the following description and the figures.

### BRIEF DESCRIPTION OF THE DRAWINGS

FIG. 1 shows a schematic representation of portions of a device for generating a data-based model copy, according to an example embodiment of the present invention.

FIG. 2 shows steps in a method for generating the data-based model copy, according to an example embodiment of the present invention.

FIG. 3 shows further steps in the method for generating the data-based model copy, according to an example embodiment of the present invention.

FIG. 4 shows further steps in the method for generating the data-based model copy, according to an example embodiment of the present invention.

### DETAILED DESCRIPTION OF EXAMPLE EMBODIMENTS

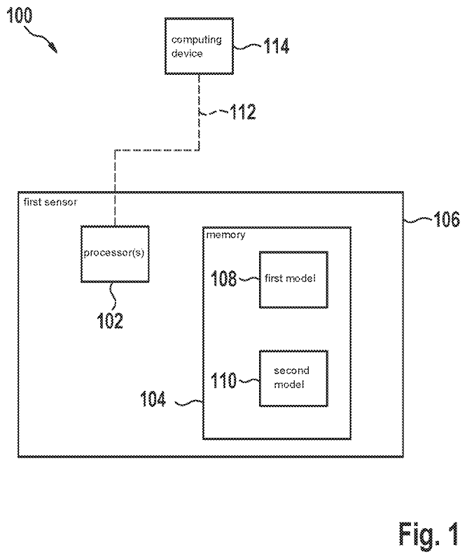

FIG. 1 schematically shows a device 100 for generating a data-based model copy. The device 100 comprises at least one processor 102 and at least one memory 104. The latter are hereinafter referred to as a computing unit.

FIG. 1 shows a first sensor 106. In the example, the first sensor 106 comprises the computing unit.

The at least one memory 104 stores a first model 108 and a specified second model 110. The first model 108 is designed to predict results based on raw data from the first sensor 106. The second model 110 is designed to predict results based on raw data from a second sensor. The second model 110 in the example is already known and is designed for this purpose, in particular by pre-training. The second model 110 in the example is adapted for the second sensor. In the example, the second model 110 is unsuitable for directly processing raw data of the first sensor 106, i.e., in particular, without transformation into a suitable data type or into a suitable format. The first model 108 in the example is not yet trained or is not yet fully trained. The first model 108 is designed to process the raw data of the first sensor 106.

The first model 108 in the example comprises a first classifier. The second model 110 in the example comprises a second classifier. The first classifier in the example is a convolutional neural network, CNN. The second classifier in the example is a convolutional neural network, CNN. An artificial neural network having a different structure may be provided instead of a CNN. A classifier that solves a regular classification problem in a different way may also be provided.

The computing unit in the example is designed to predict results with the first model 108 for raw data measured by means of the first sensor 106 and to predict results with the second model 110 for raw data corresponding to those of the second sensor, in particular in terms of the data type or format.

Optionally, the first sensor 106 comprises an interface 112 to a computing device 114 arranged outside the sensor 106. The computing device 114 may be a central control unit of a vehicle or one or more servers in an internet infrastructure.

In the computing unit, computer-readable instructions are provided, which, when executed by the computing unit, cause steps in a method described below to run. It may be provided that the computing unit and the computing device 114 are designed to respectively perform a portion of the steps and to exchange the required data with one another via the interface 112.

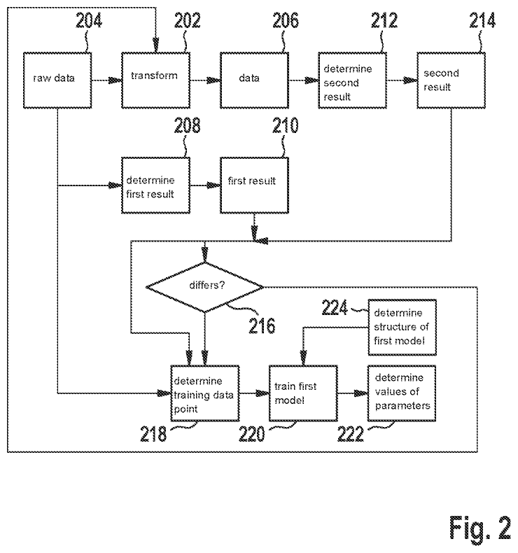

FIG. 2 schematically shows steps in the method for generating a data-based model copy.

The definition of a network architecture of the first model 108 is a technical challenge. Assuming that a network architecture is known, the remaining task is to train the network. A large amount of labeled data is required to train the first model 108 by means of a supervised classification problem. This effort has been made in the example for the network architecture and the training of the second model 110. As a result of the data-based model copy, this effort is avoided or kept as low as possible in the example for the first model 108.

The method is used, for example, for a subsequent generation of a radar sensor that has extended technical capabilities in comparison to a previous generation of the radar sensor. These technical capabilities can relate to the following properties, for example: increase in a range, a resolution, an opening angle of the radar sensor. The method can also be used for fundamental changes in radar modulation and signal analysis.

When using a data-based model in the subsequent generation, the method is used to transfer knowledge. The knowledge from traditional models can be transferred to data-based models. A data-based model of the previous generation can be adopted. In the case of the traditional model, the challenge is to integrate domain knowledge into a data-based model. In the case of data-based models, the problem arises when the sensor signals of different generations differ strongly and the possibilities of generalizing the second model 110 is exceeded.

It may be provided for the method to generate an algorithmic copy of an already existing algorithm used in a radar sensor of the previous generation on the basis of input data in a different format than in the subsequent generation. This makes it possible, for example, to use the already existing algorithm in the radar sensor of the subsequent generation, in particular for the generation of ground truth or for the identification of relevant training data for a new algorithm on the basis of the already existing algorithm. In one embodiment of the algorithms, the models are used to process the sensor data.

Instead of a radar sensor, a different sensor may also be used, in particular a LiDAR, ultrasonic, infrared, or acoustic sensor.

In a step 202, specified raw data 204 are transformed into data 206 representing raw data of the second sensor. The data 206 are, for example, generated by a transformation unit that converts raw data 204 into data 206.

The transformation unit may comprise a transformation rule or a data-based model.

The raw data 204 of the first sensor 106 are converted, in the example, into the data 206 by means of the transformation rule. The transformation rule is, for example, described mathematically or trained based on data.

It may instead be provided to convert the raw data 204 of the first sensor 106 with the data-based model. Data for a supervised training of the data-based model are, for example, provided by mounting the first sensor 106 and the second sensor in a test vehicle and recording data streams of raw data of both sensors for a representative test scope. The sought data-based model converts the raw data 204 of the first sensor 106 into raw data of the second sensor. This is, for example, achieved with a supervised training of a neural network or of a different model. It may be provided to adaptively improve the data-based model during the training, e.g., by means of an automated architecture search.

Sampling of the raw data may also be provided as a transformation.

By using this transformation, a copy based on the first sensor 106 is made possible. In the example, algorithms for both models and the transformation run on the first sensor 106, e.g., in parallel or selectively. The second sensor is not required to train the first model 108.

The method begins, for example, when the raw data 204 of the first sensor 106 are specified. They may be measured by the first sensor 106 or may be read from a memory, e.g., of the computing unit.

The raw data 204 of the first sensor 106 and those of the second sensor may characterize a time domain signal.

The raw data 204 of the first sensor 106 and the data 206 may characterize a spectrum, in particular of the radar, LiDAR, ultrasonic, infrared, or acoustic sensor.

The raw data 204 of the first sensor 106 and the data 206 may characterize a position.

The raw data 204 of the first sensor 106 and the data 206 may be filtered data or transformations of data that characterize the time domain signal, the spectrum, or the position.

In a step 208, a first result 210 is determined with the specified raw data 204 and with the first model 108.

Steps 202 and 208 are performed one after the other in the example but may also run at least partially in parallel.

In a step 212, a second result 214 is determined with the data 206 representing the raw data of the second sensor and with the specified second model 110. Step 212 in the example takes place subsequently to step 202.

It may be provided that the first result 210 and/or the second result 214 characterizes an object type.

It may be provided that the first result 210 and/or the second result 214 characterizes an estimate for a dimension of an object.

It may be provided that the first result 210 and/or the second result 214 indicate whether or not a blind sensor, clustering, or an object has been detected.

Subsequently, a step 216 is performed.

In step 216, it is determined whether or not the first result 210 differs from the second result 214.

If the first result 210 differs from the second result 214, a step 218 is performed. Otherwise, in the example, different raw data 204 are provided and step 202 is performed.

In step 218, a training data point is determined, which comprises the specified raw data 204 and the second result 214.

Subsequently, a step 220 is performed.

In step 220, the first model 108 is trained with training data comprising the training data point.

It may be provided that the training of the first model 108 takes place in a plurality of iterations.

It may be provided that values of parameters 222 defining the first model 108 are initialized with random values prior to a first one of the iterations.

It may be provided that, prior to a first one of the iterations, values of parameters 222 defining the first model 108 are determined or have been determined by training with raw data measured by means of the first sensor 106.

It may be provided that the training provides for a multitude of training data points to be determined in a number of iterations, without performing a training step. It may be provided that a training step is subsequently performed, in which parameters 222 defining the first model 108 are determined.

It may be provided that the parameters 222 are determined with a portion of the training data points from the multitude of training data points.

It may be provided that the parameters 222 are determined with the, in particular all, training data points from the multitude of training data points.

For example, training is performed when the memory 104 contains a sufficient amount of entries. This takes place either incrementally with the portion or in the full batch with all training data points from scratch. In incremental training, the memory 104 can be designed to be significantly smaller. The sufficient amount of new training data points may range from typically one new training data point to several 1000 new training data points. The lower the number of iterations without a training step, the less redundant training data points are collected between the training steps, with corresponding advantages for memory amount and balance of the data set.

Step 220 in the example is performed in the first sensor 106. It may be provided that step 220 is instead performed in a computing device 114 outside the first sensor 106.

If the first model 108 is trained in the computing device 114, it is transmitted to the computing unit of the first sensor 106 after at least one training step. The first model 108 is, for example, transmitted to the first sensor 106 via firmware over-the-air, FOTA, or via a wired firmware update.

The newly trained first model 108 is, for example, updated by updating coefficients in the computing unit of the first sensor 106. The regular time intervals may, for example, be 1/day . . . 1/month.

The method optionally comprises a step 224. In step 224, a structure of the first model 108 is determined depending on a specified structure of the second model 110. Step 224 preferably takes place prior to the first iteration.

Step 224 in the example comprises an architecture search with a machine learning system, in which architecture search the structure of the first model 108 is determined depending on a specified structure of the second model 110.

Instead, it may also be provided that step 224 comprises copying at least a portion of a specified structure of the second model 110 into the structure of the first model 108.

Instead, or in addition, it may also be provided that step 224 comprises copying values of at least a portion of specified parameters of the second model 110 to values for parameters 222 of the first model 108.

A model type of the first model 108 may, for example, correspond to a model type of the second model 110 with an input adapted to the first sensor 106. The first model 108 may also have any selected structure different from the second model 110. The first model 108 can also be adapted to a respective data situation by means of a neural architecture search, e.g., AutoML.

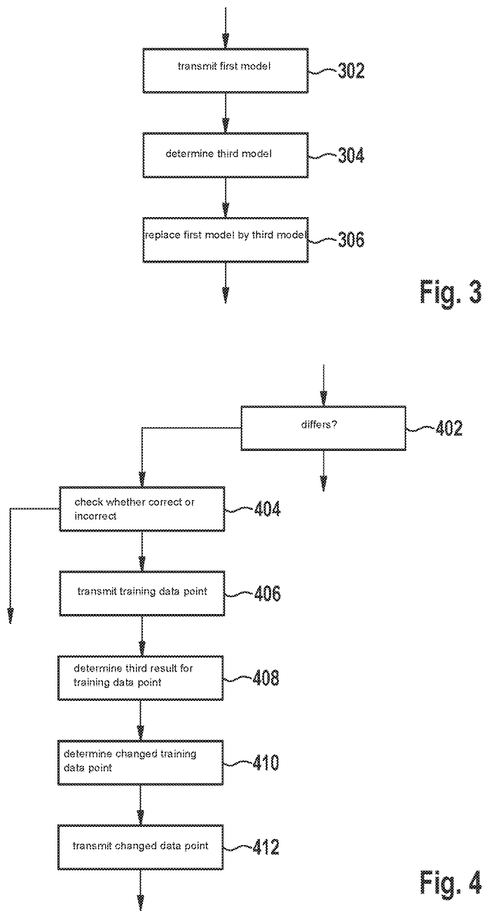

The method may also provide the following steps shown schematically in FIG. 3.

In the example, a step 302 is performed at regular time intervals.

It may be provided that a time can be specified for this purpose or that the time is specified.

In a step 302, the first model 108 is transmitted from the computing unit to the computing device 114 outside the first sensor 106.

Subsequently, a step 302 is performed.

In step 304, a third model is determined depending on the first model 108 and at least one different model. Methods such as federated learning may be used for this purpose.

Subsequently, a step 306 is performed.

In step 306, the first model 108 in the first sensor 106 is replaced by the third model. The third model in the example is a global fused model. The third model is, for example, transmitted to the first sensor 106 via firmware over-the-air, FOTA, or via a wired firmware update.

The method may also provide the following steps shown schematically in FIG. 4.

In a step 402, it is checked whether the first result 210 differs from the second result 214. If the first result 210 differs from the second result, a step 404 is performed. Otherwise, step 404 is not performed in the example. Step 402 may be implemented as part of step 216.

In step 404, it is checked whether the second result 214 for the training data point 218 is correct or incorrect.

If the second result 210 is incorrect, a step 406 is performed. Otherwise, step 406 is not performed in the example.

In step 406, the training data point 218 is transmitted to the computing device 114 outside the first sensor 106.

Subsequently, a step 408 is performed.

In step 408, a third result for the training data point 218 is determined. The third result in the example is determined with a different model designed to predict the third result for the training data point 218. In the example, the different model is an already pre-trained model.

Subsequently, a step 410 is performed.

In step 410, a changed training data point is determined by replacing the second result in the training data point 218 with the third result.

Subsequently, a step 412 is performed.

In step 412, the changed training data point is transmitted to the first sensor 106.

Subsequently, a step 414 is performed.

In step 414, the first model 108 is trained with the changed training data point.

The method may be used to make an existing model useful for a sensor of the same generation in a different installation position.

For this purpose, two or more sensors are mounted on a test vehicle in different installation positions. For a representative test scope with several sensors, corresponding data streams are processed as described.

1-15. (canceled)

16. A computer-implemented method for generating a data-based model copy in a first sensor, comprising the following steps:
transforming specified raw data from a first sensor into data representing raw data of a second sensor;
determining a first result with the specified raw data and with a first model configured to predict results based on raw data from the first sensor;
determining a second result with the data representing the raw data of the second sensor and with a specified second model configured to predict results based on raw data from the second sensor;
determining whether or not the first result differs from the second result; and
based on determining the first result differs from the second result, performing the following:
determining a training data point including the specified raw data and the second result, and
training the first model with training data including the training data point.

17. The method according to claim 16, wherein the raw data represent: (i) at least one time domain signal or at least one spectrum of: a radar sensor or LiDAR sensor or ultrasonic sensor or infrared sensor or acoustic sensor, or (ii) at least one position, or (iii) filtered data, or (iv) transformed data.

18. The method according to claim 16, wherein: (i) the first result and/or the second result characterizes an object type or an estimate for a dimension of an object, or (ii) the first result and/or the second result indicates whether or not a blind sensor or clustering or an object has been detected.

19. The method according to claim 16, wherein the training of the first model takes place in a plurality of iterations, wherein values of parameters defining the first model are initialized with random values prior to a first one of the iterations.

20. The method according to claim 16, wherein the training takes place in a plurality of iterations, wherein, prior to a first one of the iterations, values of parameters defining the first model are determined or have been determined by training with raw data measured using the first sensor.

21. The method according claim 19, wherein, in the training, a multitude of training data points is determined in a number of iterations, without performing a training step, wherein, subsequently, in the first sensor or in a computing device outside the first sensor, a training step is performed, in which parameters defining the first model are determined with a portion of the training data points from the multitude of training data points or with the training data points from the multitude of training data points.

22. The method according to claim 16, further comprising determining a structure of the first model depending on a specified structure of the second model.

23. The method according to claim 22, wherein the determining of the structure of the first model includes an architecture search with a machine learning system, in which the structure of the first model is determined depending on the specified structure of the second model.

24. The method according to claim 22, wherein the determining of the structure of the first model includes copying at least a portion of a specified structure of the second model into the structure of the first model and/or copying values of at least a portion of specified parameters of the second model to values for parameters of the first model.

25. The method according to claim 16, wherein after at least one training step in which parameters defining the first model are determined, the first model is transmitted to a computing unit of the first sensor, the computing unit being configured to predict results with the first model for raw data measured using the first sensor.

26. The method according to claim 16, wherein the first model is transmitted from the computing unit to a computing device outside the first sensor, at a specifiable or specified time, and a third model is determined depending on the first model and at least one different model, and the first model in the first sensor is replaced by the third model.

27. The method according to claim 16, wherein, based on the first result differing from the second result, performing:
transmitting the training data point to a computing device outside the first sensor;
determining a third result for the training data point with a different model configured to predict the third result for the training data point;
determining a changed training data point by replacing the second result in the training data point with the third result;
transmitting the changed training data point to the first sensor; and
training the first model with the changed training data point.

28. The method according to claim 27, further comprising checking whether the second result for the training data point is correct or incorrect, wherein the changed training data point is determined and used for the training of the first model when the second result is incorrect, and wherein the changed training data point is otherwise not determined and/or not used for the training of the first model.

29. A device configured to generate a data-based model copy in a first sensor, the device configured to:
transform specified raw data from a first sensor into data representing raw data of a second sensor;
determine a first result with the specified raw data and with a first model configured to predict results based on raw data from the first sensor;
determine a second result with the data representing the raw data of the second sensor and with a specified second model configured to predict results based on raw data from the second sensor;
determine whether or not the first result differs from the second result; and
based on determining the first result differs from the second result:
determine a training data point including the specified raw data and the second result, and
train the first model with training data including the training data point.

30. A non-transitory computer-readable medium on which is stored a computer program including computer-readable instructions for generating a data-based model copy in a first sensor, the instructions, when executed by a computer, cause the computer to perform the following steps:
transforming specified raw data from a first sensor into data representing raw data of a second sensor;
determining a first result with the specified raw data and with a first model configured to predict results based on raw data from the first sensor;
determining a second result with the data representing the raw data of the second sensor and with a specified second model configured to predict results based on raw data from the second sensor;
determining whether or not the first result differs from the second result; and
based on determining the first result differs from the second result, performing the following:
determining a training data point including the specified raw data and the second result, and
training the first model with training data including the training data point.
